(19) United States
(12) Patent Application Publication
(10) Pub. No.: US 2016/0032871 A1
(43) Pub. Date: Feb. 4, 2016

(54) LOW PRESSURE EXHAUST GAS RECIRCULATION MODULE

(71) Applicant: BORGWARNER INC., Auburn Hills, MI (US)

(72) Inventors: Robert D. KEEFOVER, Lake Orion, MI (US); Peter G. WEISSINGER, Sterling Heights, MI (US)

(73) Assignee: BORGWARNER INC., Auburn Hills, MI (US)

(21) Appl. No.: 14/774,162

(22) PCT Filed: Mar. 12, 2014
(86) PCT No.: PCT/US2014/024292

§ 371 Date: Sep. 10, 2015

Related U.S. Application Data
(60) Provisional application No. 61/787,324, filed on Mar. 15, 2013.

(51) Int. Cl. F02M 25/07; F01P 3/14; F02B 33/40

(52) U.S. Cl. CPC F02M 25/0771; F02B 33/40; F02M 25/0793; F02M 25/0734; F02M 25/0719; F01P 3/14

(57) ABSTRACT

One variation may include an assembly comprising a housing assembly having an exhaust flow port and an EGR flow port formed therein, an exhaust flow port valve plate received in the housing assembly constructed and arranged to move to a position to at least partially block flow of gas through the exhaust flow port, and an EGR port valve plate received in the housing assembly and constructed and arranged to move to a position to at least partially block gas through the EGR flow port, and a single actuator connected to move both of the exhaust flow port valve plate and the EGR flow port valve plate. Another variation may include a combined low pressure exhaust gas recirculation valve and exhaust throttle valve including first and second valve plates connected to a common valve shaft in spaced apart relationship.

### CROSS-REFERENCE TO RELATED APPLICATIONS

This application claims the benefit of U.S. Provisional Application Ser. No. 61/787,324 filed Mar. 15, 2013.

### TECHNICAL FIELD

The field to which the disclosure generally relates to includes exhaust gas recirculation (EGR) valves, systems including EGR valves and methods of making and using the same.

### BACKGROUND

Oxides of nitrogen (NOₓ) are one of the exhaust gas emissions that must be controlled. Formation of NOₓ will occur at higher combustion temperatures. A system, referred to as an exhaust gas recirculation (EGR) system, has been developed to reduce excess oxygen and combustion temperatures of engines to control NOₓ emissions. In an EGR system a portion of the exhaust gas is recirculated back to the intake of a combustion engine where it is combined with incoming air reducing excess oxygen content in the total air mixture. When this mixture is compressed and ignited in a combustion engine cylinder, the result is a reduction in NOₓ due to reduced oxygen content and lower combustion temperature.

### SUMMARY OF ILLUSTRATIVE VARIATIONS OF THE INVENTION

One illustrative variation may include an assembly comprising a housing assembly having an exhaust flow port and an EGR flow port formed therein, an exhaust flow port valve plate received in the housing assembly constructed and arranged to move to a position to at least partially block flow of gas through the exhaust flow port, and an EGR port valve plate received in the housing assembly constructed and arranged to move to a position to at least partially block gas through the EGR flow port, and a single actuator connected to move both of the exhaust flow port valve plate and the EGR flow port valve plate.

Another illustrative variation includes a combined low pressure exhaust gas recirculation valve and exhaust throttle valve including first and second valve plates connected to a common valve shaft in spaced apart relationship.

Other illustrative variation of the invention will become apparent from the detailed description provided hereinafter. It should be understood that the detailed description and specific examples, while disclosing select illustrative variation of the invention, are intended for purposes of illustration only and are not intended to limit the scope of the invention.

### BRIEF DESCRIPTION OF THE DRAWINGS

Illustrative variations of the invention will become more fully understood from the detailed description and the accompanying drawings, wherein:

FIG. 1 is a schematic illustration of an engine breathing system.

FIG. 2 is a schematic illustration of an engine breathing system according to one variation.

FIG. 3 is a side view of an assembly with portions sectioned and removed according to one variation.

FIG. 4A is a prospective view of an assembly including portions sectioned and removed according to one variation.

FIG. 4B is a prospective view of an assembly including portions sectioned and removed according to one variation

FIG. 5A is a top view illustrating the valve plate configuration for one variation.

FIG. 5B is a side view illustrating the valve plate configuration for one variation.

FIG. 6 is a graph of EGR flow curves for several variations.

FIG. 7 is a graph of flow versus back pressure for several variations.

FIG. 8 is a side view illustrating a modified throttle valve plate with tip radius according to one variation.

FIG. 9 illustrates an assembly including a cast iron valve housing and a cast aluminum actuator housing according to one variation.

FIG. 10 illustrates a cast iron exhaust valve housing and a cast aluminum actuator and EGR valve housing according to one variation.

FIG. 11 illustrates an assembly including a single piece complete cast aluminum actuator and valve housing including a water cooling jacket according to one variation.

FIG. 12 illustrates a valve plate assembly and installation method for dual throttle bore housing assemblies according to one variation.

### DETAILED DESCRIPTION OF SELECT ILLUSTRATIVE VARIATIONS

The following description of the variation(s) is merely illustrative in nature and is in no way intended to limit the invention, its application, or uses.

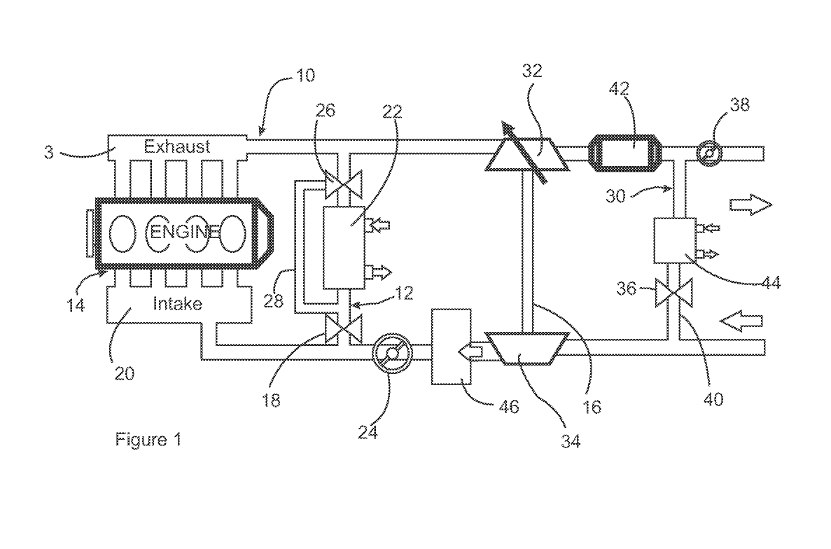

A schematic of an engine breathing system 10 is shown in FIG. 1. The engine breathing system includes a “high pressure” EGR loop 12 named because the EGR loop operates on the high pressure side of the system between the combustion engine 14 and the turbocharger 16. The high pressure EGR loop 12 may include an EGR valve that controls the flow of exhaust gas to the intake manifold 20. As shown in FIG. 1, the high pressure EGR loop valve 18 may be positioned after “cold side” a high pressure loop exhaust gas cooler 22, but may also be positioned upstream of the cooler 22 (on the hot side). As the EGR valve 18 opens, it will increase and decrease the flow rate of exhaust gas to the intake manifold 20. It is also typical to have a throttle valve 24 positioned in the air intake side to control air flow and pressure in the intake manifold 20. The exhaust gas cooler 22 may be used to reduce the temperature of the circulated exhaust gas, but if desired a cooler bypass valve 26 may be positioned with an associated bypass line 28 to bypass exhaust gas around the cooler 22 under certain operating conditions.

To further reduce NOₓ and improve vehicle fuel economy, an additional “low pressure” EGR loop 30 may be added that operates on the low pressure side of the turbocharger 16 after the exhaust turbine 32 and before the air intake turbo compressor 34. This system may consist of a low pressure loop EGR valve 36 to control the flow of exhaust gas to the air intake side, and a low pressure loop throttle valve 38 in the exhaust side to control the exhaust back pressure needed to drive the exhaust gas flow through the low pressure EGR loop line 40. The EGR loop 30 may also include a diesel oxidation catalyst (DOC) and diesel particulate filter (DPF) 42 and a second exhaust gas cooler 44 in the low pressure EGR loop 30 to cool gas going through the low pressure EGR loop. Low pressure loop exhaust gas has the additional advantage of passing through the air charge cooler 46 positioned after (downstream) the compressor portion 34 of the turbocharger 16 before reaching the combustion engine 14. Similar to the high pressure loop 12, the low pressure loop valve 36 can be placed either before (hot side) or after (cold side) the low pressure loop exhaust gas cooler 44.

EGR valves 18, 36 may be actuated by a pneumatic or electric means. Pneumatically actuated valves depend upon the availability of pressure or vacuum on the vehicle and this may be an undesirable requirement. They also require a means for electrically controlling the pneumatic source to allow overall electrical control of the system. An electric vacuum or a pressure regulator is used to provide this control. Operating force is another factor used in the selection criteria for the type of actuator used for EGR valves. Higher gas flow rates require larger valves with greater area and higher operating forces. Lower pressure differential between the exhaust and intake manifold require large valves to achieve the desired flow rate. Contamination in the exhaust gas can accumulate on the valve components and cause them to stick or resist movement if sufficient operating force is not available.

The type of valve useful for a particular application is usually at least partially driven by the required EGR flow rate. Single poppet valves are well suited for typical engine applications because of their good characteristics in the area of low gas leakage past the valve when the valve is closed. Because the operating forces required typically increase with the valve size, for higher EGR flow rates in moderately sized engines dual poppet valves (2 poppet valves on the same shaft) are often chosen. A dual poppet valve increases the flow capacity of a poppet valve while balancing and reducing the required operating forces. For very high EGR flow rates in large engine applications, where the poppet valve or dual poppet valves would need to be very large (greater than 32 mm in diameter), a throttle valve or butterfly valve potentially becomes an attractive solution.

EGR valves and other valves that control the flow of high temperature fluids, may have components that are sensitive to high temperature. These components may include: actuators, shaft seals, bearings, position sensors, and plastic molded parts. Typically actuators may include: pneumatic devices, linear solenoids, torque motors, stepper motors, and DC motors. Additional measures such as liquid cooling, heat shields, remote mounting, or use of expensive materials may be required to achieve suitable durability when operating at high temperatures.

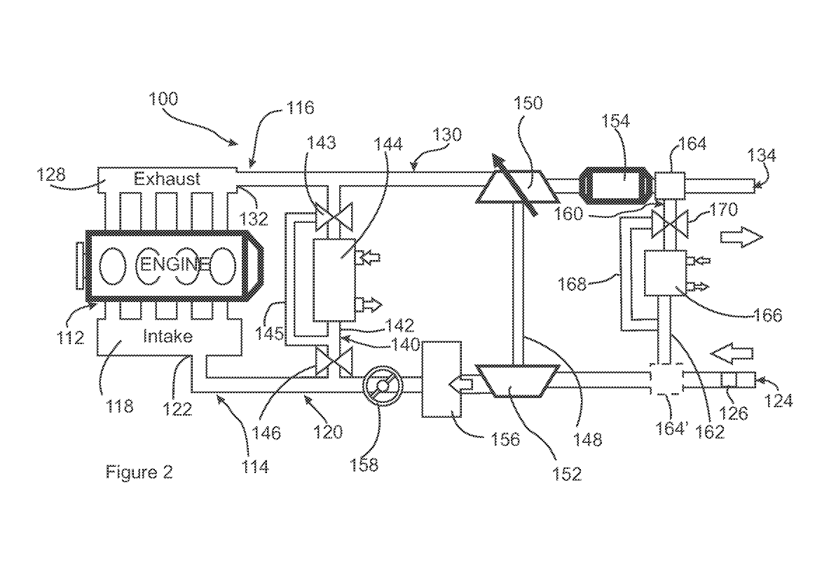

FIG. 2 is a schematic illustration of a product or system 10 including a modern engine breathing system. Such a system 100 may include a combustion engine 112 constructed and arranged to combust a fuel such as a diesel fuel, gasoline or other combustible fuel in the presence of oxygen (air). The system 100 may further include a breathing system including air intake side 114 and a combustion gas exhaust side 116. The air intake side 114 may include an air intake manifold 118 connected to the combustion engine to feed air into the cylinders of the combustion engine 112. A primary air intake conduit 120 may be provided and connected at one end 122 to the air intake manifold 118 (or made part thereof) and may include an open end 124 for drawing air there through. An air filter 126 may be located at or near the open end of the primary air intake conduit 120.

The combustion gas exhaust side 116 may include an exhaust manifold 128 connected to the combustion engine 112 to exhaust gases there from. The combustion gas exhaust side 116 may further include a primary exhaust gas conduit 130 having a first end 132 connected to the exhaust manifold 128 (or made part thereof) and having an open end 134 for discharging exhaust gas to the atmosphere.

Such a system may optionally include a first (high pressure loop) exhaust gas recirculation assembly 140 extending from the combustion gas exhaust side 116 to the air intake side 114. A first (high pressure loop) EGR valve 146 may be provided in fluid communication with the primary exhaust gas conduit 130 and construct and arrange to control the flow of exhaust gas from the exhaust side 116 to the air intake side 114 and into the combustion engine 112. The first EGR assembly 140 may include a primary EGR line 142 having a gas cooler 144 in fluid communication therewith for cooling the exhaust gas flowing through the primary EGR line 142. Optionally a cooler bypass line 145 may be connected to the primary EGR line 142 and a bypass valve 143 may also be provided to selectively control the flow of exhaust gas around the first gas cooler 144.

The system 100 may further include a turbocharger 148 having a turbine 150, which may have a variable geometry, in fluid communication with the primary exhaust gas conduit 130 and having a compressor 152 in fluid communication with the primary air intake conduit 120 to compress gases flowing there through. An air charge cooler 156 may be provided in the primary air intake conduit 120 downstream of the compressor 152. In one variation, the compressor 152 may be a variable pressure compressor constructed and arranged to vary the pressure of gas at a given flow rate. An air throttle valve 158 may be provided in the primary air intake conduit 120 preferably downstream of the air charge cooler 156.

A number of emission control components may be provided in the primary exhaust gas conduit 130. For example, emission control component 154 may be a particulate filter, a catalytic converter, or a combination of a catalytic converter and particulate filter which may be provided downstream of a turbine 150 and additional emission control components can also be provided such as a muffler (not shown) as desired. Additional exhaust after-treatment devices such as a lean NOₓ trap may be provided in the exhaust side 130.

A second low pressure EGR assembly 160 may be provided connecting the exhaust gas side 130 at a position downstream of the turbine 150 on the exhaust side 130 and upstream of the air compressor 152 on the air intake side 120. The second EGR assembly 160 may include a second EGR line 162 connecting the exhaust gas side 130 to the air intake side 120. A combination EGR valve and exhaust throttle valve assembly 164 may be connected, in one variation, at the juncture of the second EGR line 162 and the exhaust gas side 130. A second EGR cooler 166 may be provided in the second EGR line 162 and if desired a bypass conduit 168 may be constructed and arranged to flow exhaust gas from the second EGR line 164 around the second EGR cooler 166 with the aid of a second bypass valve 170. In an alternative variation, a valve 164′ may be positioned at the juncture of the air intake 120 and the second EGR line 162. The valve 164′ may be provided as a substitute for the valve 164 or in addition thereto.

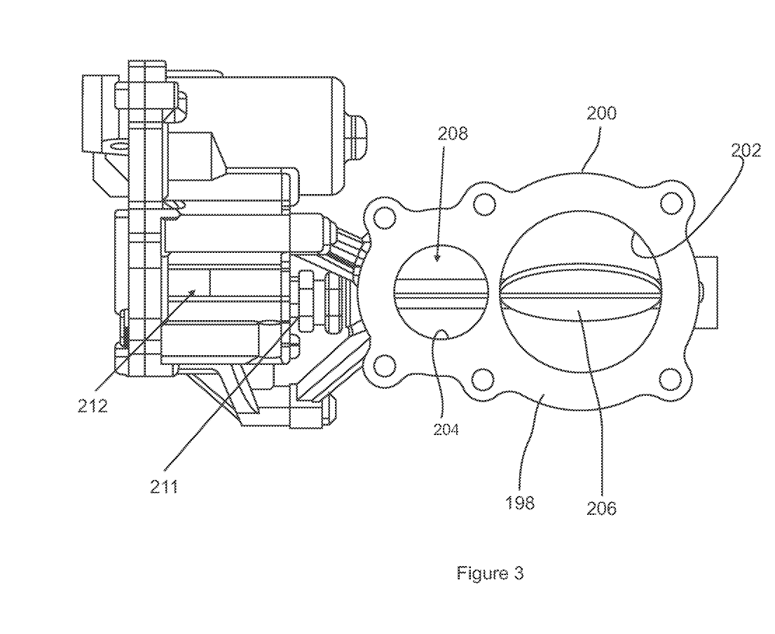

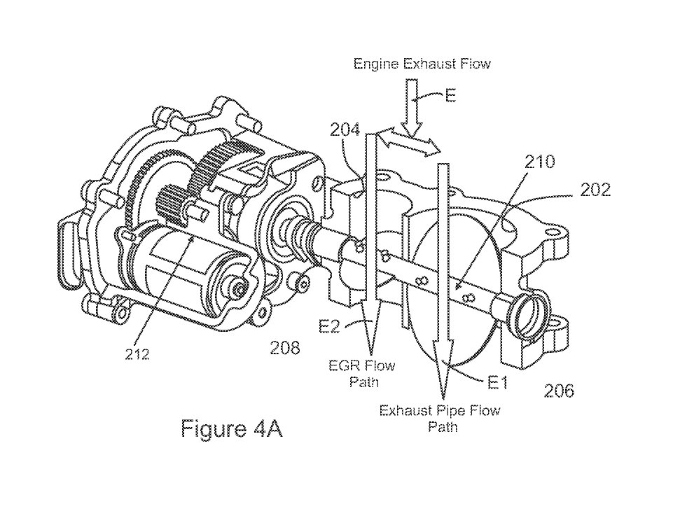

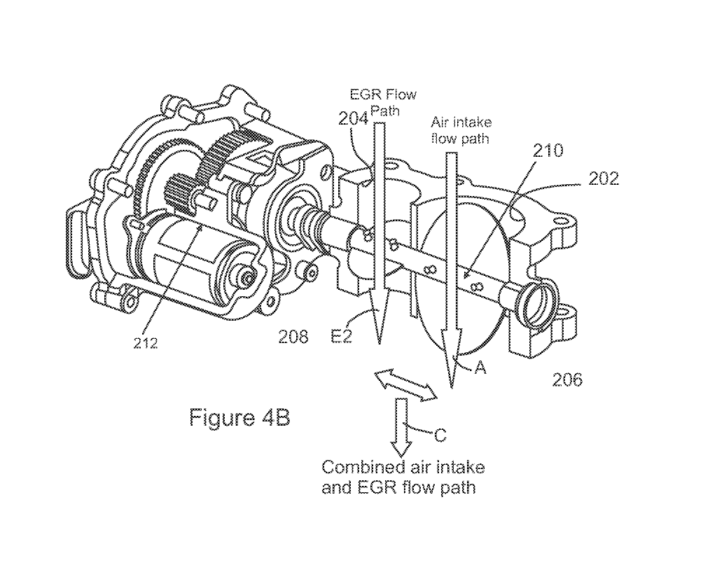

FIG. 3 illustrates one variation of the invention including an assembly 198 having a housing 200 having formed therein an exhaust flow port 202, and an EGR flow port 204. The assembly 198 includes an exhaust flow port valve plate 206 received in the housing 200 of the assembly 198 and constructed and arranged to selectively open and close the exhaust flow port 202. The assembly also includes an EGR flow port valve plate 208 received in the housing 200 of the assembly and constructed and arranged to open and close the EGR flow port 204. The exhaust flow port valve plate 206 and the EGR flow port valve plate 208 may be connected together, for example, by a common shaft 210. The common shaft 210 may have bends or may be straight without bends. An actuator 212, which may be an electric rotary actuator, may be connected to the common shaft 210 to rotate the exhaust flow port valve plate 208. The actuator 212 may be air or water cooled and a shaft coupling 211 may be provided In the variation shown in FIG. 3, the EGR flow port 204 is closed by the EGR flow port valve plate 206 and the exhaust flow port valve 206 is in a position to allow exhaust to flow through the exhaust flow port 202. A perspective view with portions sectioned is shown in FIG. 4A. Exhaust gas flow shown by arrow E is split into exhaust flow port path (shown by arrow E) that goes through the exhaust flow port 202 and into EGR flow path (shown by arrow E2) that goes through the EGR port 204. In one variation, as shown in FIG. 4, the exhaust port valve plate 206 and the EGR port valve plate 208 may be connected to a straight common shaft 210 at different angles with respect to the axis of the common shaft 210.

Referring to FIGS. 2 and 4B, again in one alternative variation a valve 164′ may be positioned at the juncture of the air intake 120 and the second EGR line 162. The valve 164′ may be provided as a substitute for the valve 164 or in addition thereto. A perspective view with portions sectioned of a valve 164′ positioned at the juncture of the air intake 120 and the second EGR line 162 is shown in FIG. 4B. Air intake flow shown by arrow A and EGR gas flow is shown by arrow E2. A combine flow shown as arrow C exits the assembly when the valve 164′ is positioned at the juncture of the air intake 120 and the second EGR line 162. In one variation, as shown in FIG. 4B, the valve plate 206 and the valve plate 208 may be connected to a straight common shaft 210 at different angles with respect to the axis of the common shaft 210.

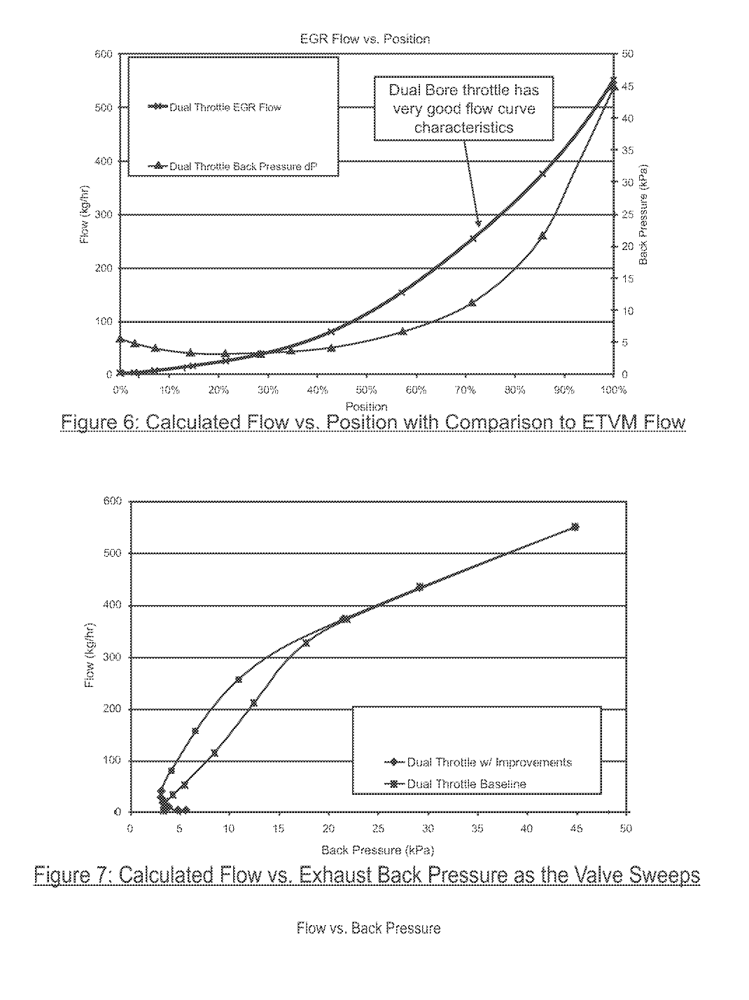

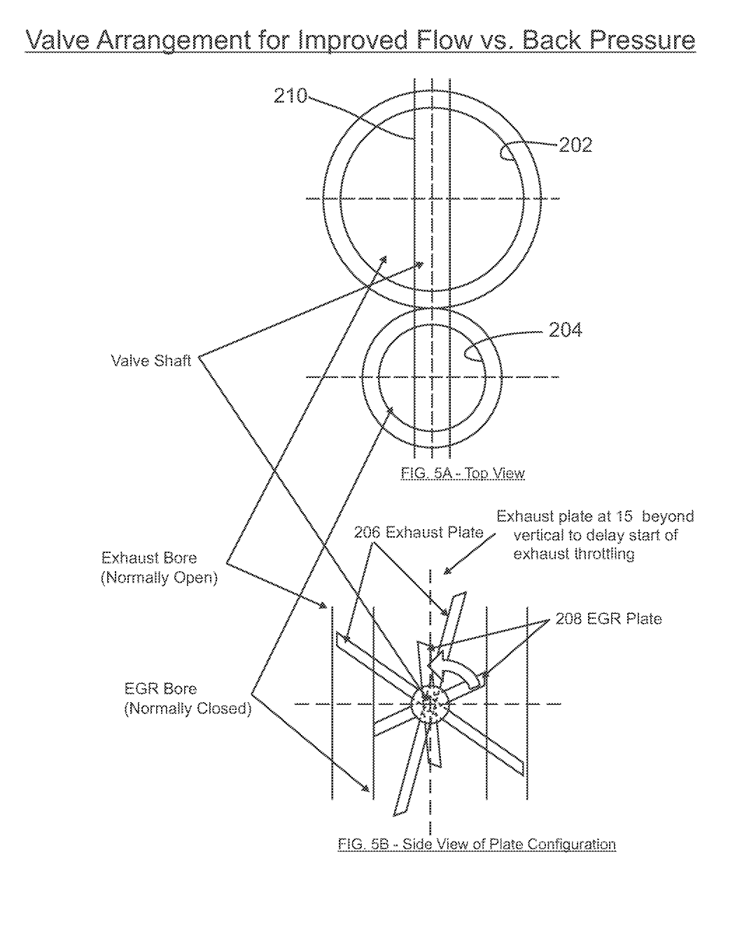

FIGS. 5A-5B illustrate the movement of the exhaust flow valve plate 206 from a position which is about 15 degrees beyond vertical (dotted line) to delay start of exhaust throttling to a position wherein exhaust gas is substantially blocked by valve plate 206. At the same time, the EGR flow port valve plate 208 moves from a position in which exhaust gas is substantially blocked by the EGR port to a position in which the EGR flow port valve plate 208 allows gas to flow through the EGR port wherein plate 206 is parallel or substantially parallel to vertical (dotted line).

Referring again to the variations shown in FIGS. 3-4, the two throttle valves plate 206, 208 may share a common shaft 210 that rotates each valve plate simultaneously when actuated. In one variation the valve may have three modes of functional operation: 1) “no EGR”—wherein the exhaust valve port 202 was open while the EGR valve port 204 is closed such that the engine exhaust passes only through the main tail pipe exhaust port 202; 2) “mid-EGR rates”—wherein as the valve shaft rotates, the exhaust valve port 202 begins to close while the EGR valve port 204 begins to open allowing some amount of EGR flow; 3) “maximum EGR rate”—wherein as the valve continues to rotate, the exhaust valve port 202 becomes partially to fully closed at a point where the EGR port 204 is fully open or substantially open driving the maximum amount of exhaust gas through the EGR port 204.

FIG. 6 is a graph of EGR flow versus actuator position for one illustrative variation. The resulting flow curve is rather good from the viewpoint of controllability with a gradually increasing slope with no sudden changes in slope and no plateaus. The ability of this type of valve arrangement to deliver a certain type of EGR flow while minimizing the amount of back pressure required for the flow is an important system consideration when low back pressure generally leads to improved vehicle economy and lower CO2 emissions.

FIG. 7 is a graph of flow versus back pressure for one exemplary variation as the valve arrangement sweeps from no EGR to maximum EGR position. It can be seen that for a baseline configuration there is a general increase in the required back pressure for the low to medium EGR flow rates when compared to other variations. This behavior is due to direct coupling of both plates in a common shaft such that it is not possible to open the EGR valve completely without beginning to close the exhaust valve.

FIG. 7 also shows the potential improvement in flow versus back pressure performance that may be obtained with a relatively simple modification of the base line arrangement as shown in FIGS. 5A-5B. In the modified arrangement, the exhaust valve is positioned at an angle beyond the vertical plate position wherein the exhaust throttle valve is in a closed position. This arrangement has the benefit of delaying the closing of the exhaust throttle valve relative to the opening of the EGR valve and therefore reduces the system back pressure in the low to medium EGR flow rates. However, this arrangement potentially has the disadvantage of increasing the exhaust back pressure in the no EGR position where compared to a vertical exhaust plate arrangement.

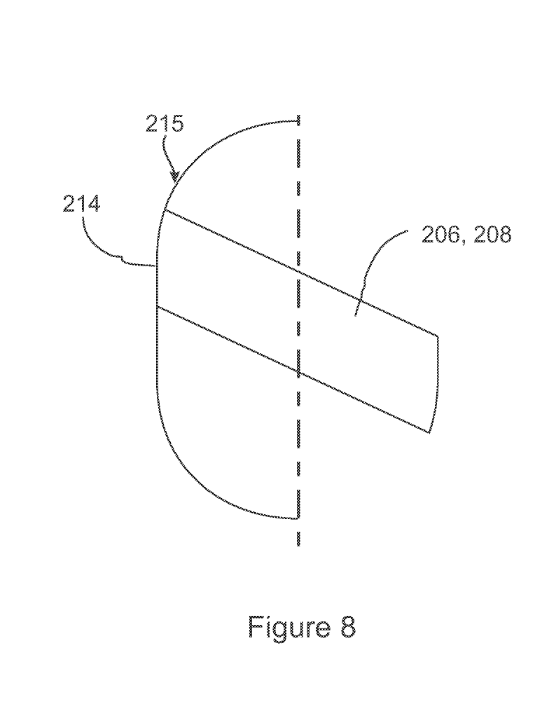

FIG. 8 illustrates a modified throttle valve concept in which the side edges 214 of the valve plate (e.g. 206/208) have an arcuate shaped valve plate tip 214 to reduce the risk of gouging the housing wall defining the bore port. The additional arcuate shaping of the edge 214 of the throttle plates provides the advantage of reducing the likelihood of the valve being wedged due to differential thermal expansion or due to thermal gradients. Line 215 illustrates the path a lathe cutter or tool shaping device might take to form the arcuate side 214.

In several variations, the valve shafts may be coupled together or integrated together in a number of ways. The two throttle valve plates 206, 208 may include a common valve shaft 210 or they may be coupled with a coupling system to coordinate the movement of both plates 206, 208 with or without lost motion. In one variation the actuator may be connected to a shaft which is connected to one of the exhaust valve plate 206 or EGR valve plate 208 and a link is provided connecting the other plate so that movement of the shaft moves both plates 206, 208. Additionally, the actuator may be coupled to the valve assembly directly with a common valve shaft or through a coupling mechanism. It is also possible to mount the actuator remotely from the valves and to couple the actuator to the valves using a lever arrangement or four bar link mechanism.

In another variation of the invention, the combined low pressure EGR and exhaust throttle assembly may be operated by a different method wherein four modes of functional operation are achieved: 1) no EGR flow rate—wherein the EGR port is fully closed and the exhaust path fully opened; 2) mid EGR rates—wherein the EGR port is partially to fully open and the exhaust flow path fully open; 3) maximum EGR flow rate—wherein the EGR port is fully open and the exhaust path partially to fully closed; and 4) full throttling—wherein the EGR port is fully closed and the exhaust path is partially to fully closed.

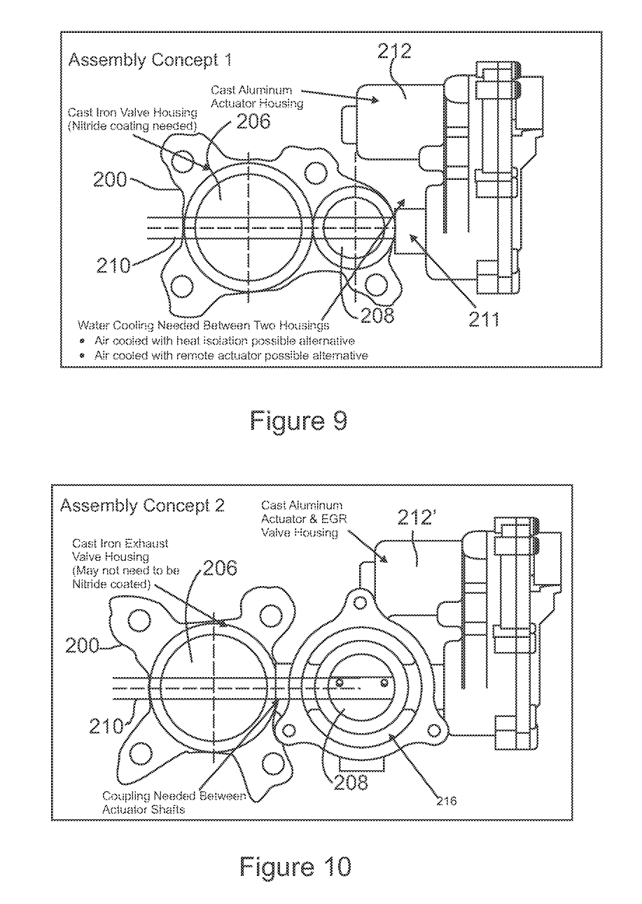

Referring now to FIG. 9, one variation may include an assembly including a cast iron valve housing 200 which is a single piece constructed and arranged to receive the exhaust valve plate 206 and the EGR valve plate 208 with a common shaft 210 received in the cast iron valve housing 200. Cast aluminum actuator housing is provided which may be coupled to the shaft 210. A variety of cooling methods are contemplated including water cooling between the two housings 200, 212, air cooling with heat isolation between the housings, or the cast iron housing 200 may be air cooled and the actuator may be remotely located.

Referring now to FIG. 10, another variation includes an assembly including a cast iron exhaust valve housing 200 receiving the exhaust valve plate 206. The assembly may also include a combination cast aluminum actuator and EGR valve housing 212′ which receives the EGR valve plate 208. The common shaft 210 extends through both the exhaust valve housing 200 and the combination actuator and EGR valve housing 212′. The portion of the actuator EGR valve housing surrounding the EGR valve plate 208 may be water cooled using a water cooling jacket 216.

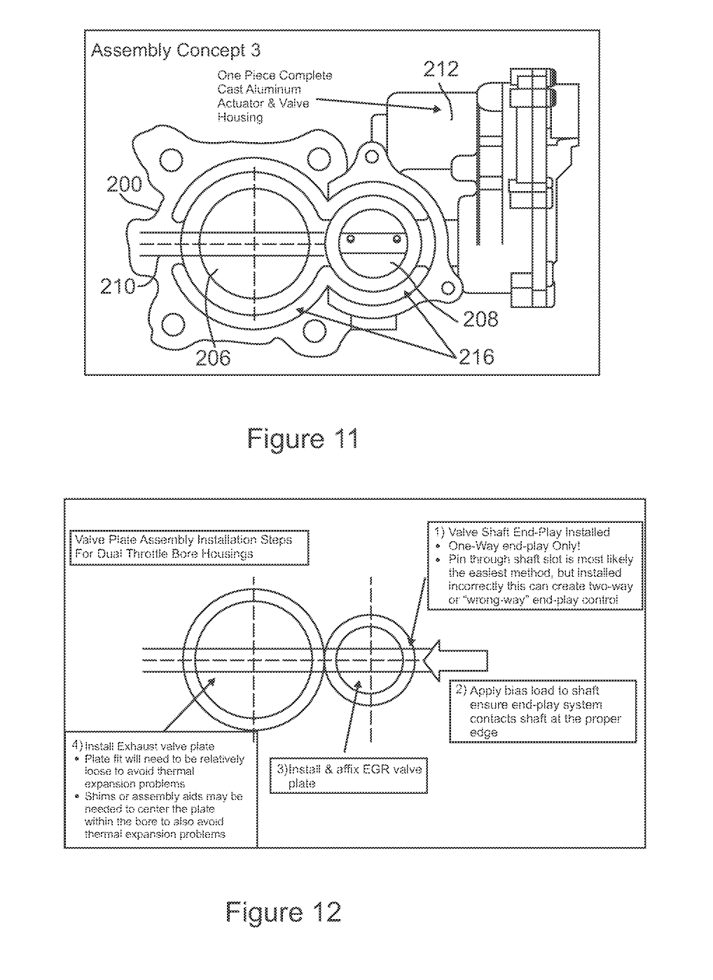

Referring now to FIG. 11, another variation may include a one-piece complete cast aluminum actuator and valve housing 200 having a portion which receives the exhaust valve plate 206 and the EGR valve plate 208. A water cooling jacket 216 may surround the valve plate. A portion of the housing 200 may receive the actuator motor.

FIG. 12 illustrates a design and method of making a valve plate assembly including installing a valve shift with a one way only and a pin through the shaft slot. A biasing load to the shaft may be provided to ensure system contacts shaft at the proper edge. The EGR valve may be installed and affixed. Then the exhaust valve plate may be installed to be relatively loose to avoid thermal expansion problems and shims or assembly aids may be needed to center the plate within the bore to also avoid thermal expansion problems.

The following is a description of select illustrative variations within the scope of the invention. However, the invention is not limited to the specific variation described hereafter, and each variation or the elements or steps thereof may be used alone or in combination with any of the other variations or elements or steps thereof.

Variation 1 may include an assembly comprising a housing assembly having an exhaust flow port and an EGR flow port formed therein, an exhaust flow port valve plate received in the housing assembly constructed and arranged to move to a position to at least partially block flow of gas through the exhaust flow port, and an EGR port valve plate received in the housing assembly and constructed and arranged to move to a position to at least partially block gas through the EGR flow port, and a single actuator connected to move both of the exhaust flow port valve plate and the EGR flow port valve plate.

Variation 2 may include an assembly as set forth in variation 1 further comprising a shaft connected to the actuator and directly connected to at least one of the exhaust flow port valve plate or the EGR flow port valve plate.

Variation 3 may include an assembly as set forth in any of variations 1-2 and further comprising a shaft connected to the actuator and directly connected to each of the exhaust flow port valve plate and the EGR flow port valve plate.

Variation 4 may include an assembly as set forth in any of variation 1-3 and further comprising a first housing and wherein at least one of the exhaust flow port valve plate and the EGR flow port valve plate is received in the housing.

Variation 5 may include an assembly as set forth in any of variation 1-4 wherein the actuator is received in the housing assembly.

Variation 6 may include an assembly as set forth in any of variation 1-6 wherein the housing is constructed and arrange to provide a water cooling jacket for the flow of cooling water therethrough.

Variation 7 may include an assembly as set forth in any of variations 1-6 wherein the housing assembly comprising a means for housing the exhaust flow port valve plate, the EGR port valve plate and the actuator.

Variation 8 may include an assembly as set forth in any of variations 1-7 further comprising a common shaft connected to the single actuator and each of the exhaust flow port valve plate and the EGR flow port valve plate, and wherein the common shaft is straight without bends, and wherein the assembly is constructed and arranged so that the exhaust flow port valve plate is moveable from a position of about 15 degrees beyond vertical to delay start of the exhaust throttling to a position wherein exhaust gas flows past the exhaust flow port valve plate.

Variation 9 may include an assembly as set forth in any of variations 1-8 wherein the assembly is constructed and arranged so the exhaust flow port valve plate and the EGR flow port valve plate are moveable to provide at least three modes of operation: 1) wherein the exhaust valve port was open while the EGR valve port is closed such that the engine exhaust passes only through exhaust port; 2) wherein as the valve shaft rotates, the exhaust valve port begins to close while the EGR valve port begins to open allowing some amount of EGR flow; 3) wherein as the valve continues to rotate, the exhaust valve port becomes partially to fully closed at a point where the EGR port is fully open or substantially open driving the maximum amount of exhaust gas through the EGR port.

Variation 10 may include an assembly as set forth in any of variations 1-8 wherein the assembly is constructed and arranged so the exhaust flow port valve plate and the EGR flow port valve plate are moveable to provide at least four modes of operation: 1) wherein the EGR port is fully closed and the exhaust path fully opened; 2) wherein the EGR port is partially to fully open and the exhaust flow path fully open; 3) wherein the EGR port is fully open and the exhaust path partially to fully closed; and 4) wherein the EGR port is fully closed and the exhaust path is partially to fully closed.

Variation 11 may include an assembly as set forth in any of variations 1-10 further comprising a turbocharger comprising a turbine connected to an exhaust conduit and a compressor connected to an air intake conduit, and wherein the exhaust conduit is connected to the exhaust port of the housing assembly, an EGR line connected to the EGR port of the housing assembly and to the air intake line so the housing assembly is downstream of the turbine.

Variation 12 may include an assembly as set forth in any of variations 1-11 wherein the exhaust flow port valve plate and the exhaust flow port valve plate are connected to the common shaft at different angle with respect to the axis of the common shaft.

Variation 13 may include an assembly as set forth in any of variations 1-12 wherein the exhaust flow port valve plate comprises a side edge having an arcuate shaped. Variation 14 may include an assembly as set forth in any of variations 1-13 wherein the housing assembly comprises housing comprising aluminum and receive the ERG port valve plate and the actuator.

Variation 15 may include an assembly as set forth in any of variations 1-14 wherein the housing comprising aluminum receives the exhaust port valve plate.

Variation 16 may include a product comprising a combined low pressure exhaust gas recirculation valve and exhaust throttle valve including a first plate and a second valve plate, both the first plate and the second valve plate being connected to a common valve shaft in a spaced apart relationship.

Variation 17 may include a product as set forth in variation 16 wherein the common shaft is straight.

Variation 18 may include an assembly as set forth in any of variations 1-17 further comprising a shaft connected to the actuator and directly connected to at least one of the exhaust flow port valve plate or the EGR flow port valve plate, and a link connecting the other of the exhaust flow port valve plate or the EGR flow port valve plate to the shaft.

Variation 19 may include an assembly as set forth in variations 16-18 and further comprising a single actuator connected to the shaft to rotate the same.

Variation 19 may include an assembly as set forth in variations 18 and further comprising a means for housing the first plate, the second valve plate and the actuator.

The above description of variations of the invention is merely exemplary in nature and, thus, variations thereof are not to be regarded as a departure from the spirit and scope of the invention.

What is claimed is:

1. An assembly comprising a housing assembly having a first exhaust flow port and a second exhaust flow port formed therein, a first exhaust flow port valve plate received in the housing assembly constructed and arranged to move to a position to at least partially block flow of gas through the first exhaust flow port, and a second port valve plate received in the housing assembly and constructed and arranged to move to a position to at least partially block gas through the second exhaust flow port, and a single actuator connected to move both of the first exhaust flow port valve plate and the second exhaust flow port valve plate.

2. An assembly as set forth in claim 1 further comprising a shaft connected to the actuator and directly connected to at least one of the first exhaust flow port valve plate or the second flow port valve plate.

3. An assembly as set forth in claim 1 further comprising a shaft connected to the actuator and directly connected to each of the exhaust flow port valve plate and the second flow port valve plate.

4. An assembly as set forth in claim 3 further comprising a first housing and wherein at least one of the first exhaust flow port valve plate and the second flow port valve plate is received in the housing.

5. An assembly as set forth in claim 4 wherein the actuator is received in the housing assembly.

6. An assembly as set forth in claim 4 wherein the housing is constructed and arrange to provide a water cooling jacket for the flow of cooling water therethrough.

7. An assembly as set forth in claim 1 wherein the housing assembly comprising a means for housing the exhaust flow port valve plate, the EGR port valve plate and the actuator.

8. An assembly as set forth in claim 1 further comprising a common shaft connected to the single actuator and each of the exhaust flow port valve plate and the EGR flow port valve plate, and wherein the common shaft is straight without bends, and wherein the assembly is constructed and arranged so that the first exhaust flow port valve plate is moveable from a position of about 15 degrees beyond vertical to delay start of the exhaust throttling to a position wherein exhaust gas flows past the first exhaust flow port valve plate.

9. As assembly as set forth in claim 1 wherein the assembly is constructed and arranged so the first exhaust flow port valve plate and the second flow port valve plate are moveable to provide at least three modes of operation: 1) wherein the first exhaust valve port was open while the second valve port is closed such that the engine exhaust passes only through exhaust port; 2) wherein as the valve shaft rotates, the exhaust valve port begins to close while the second exhaust valve port begins to open allowing some amount of EGR flow; 3) wherein as the valve continues to rotate, the first exhaust valve port becomes partially to fully closed at a point where the second exhaust port is fully open or substantially open driving the maximum amount of exhaust gas through the second exhaust port.

10. As assembly as set forth in claim 1 wherein the assembly is constructed and arranged so the first exhaust flow port valve plate and the second exhaust flow port valve plate are moveable to provide at least four modes of operation: 1) wherein the second exhaust port is fully closed and the exhaust path fully opened; 2) wherein the second exhaust port is partially to fully open and the exhaust flow path fully open; 3) wherein the second exhaust port is fully open and the exhaust path partially to fully closed; and 4) wherein the second exhaust port is fully closed and the exhaust path is partially to fully closed.

11. An assembly as set forth in claim 1 further comprising a turbocharger comprising a turbine connected to an exhaust conduit and a compressor connected to an air intake conduit, and wherein the exhaust conduit is connected to the exhaust port of the housing assembly, an EGR line connected to the second exhaust port of the housing assembly and to the air intake line so the housing assembly is downstream of the turbine.

12. An assembly as set forth in claim 3 wherein the first exhaust flow port valve plate and the second exhaust flow port valve plate are connected to the common shaft at different angle with respect to the axis of the common shaft.

13. An assembly as set forth in claim 1 wherein the first exhaust flow port valve plate comprises a side edge having an arcuate shaped.

14. An assembly as set forth in claim 1 wherein the housing assembly comprises housing comprising aluminum and receive the second exhaust port valve plate and the actuator.

15. An assembly as set forth in claim 14 wherein the housing comprising aluminum receives the first exhaust port valve plate.

16. A product comprising a combined low pressure exhaust gas recirculation valve and exhaust throttle valve including a first plate and a second valve plate, both the first plate and the second valve plate being connected to a common valve shaft in a spaced apart relationship.

17. A product as set forth in claim 16 wherein the common shaft is straight.

18. An assembly as set forth in claim 1 further comprising a shaft connected to the actuator and directly connected to at least one of the exhaust flow port valve plate or the EGR flow port valve plate, and a link connecting the other of the exhaust flow port valve plate or the EGR flow port valve plate to the shaft.

19. An assembly as set forth in claim 16 further comprising a single actuator connected to the shaft to rotate the same.

20. An assembly as set forth in claim 19 further comprising a means for housing the first plate, the second valve plate and the actuator.
